(19) United States
(12) Patent Application Publication
(10) Pub. No.: US 2009/0091709 A1
(43) Pub. Date: Apr. 9, 2009

(54) STEREO PROJECTION OPTICAL SYSTEM

(75) Inventors: I-PEN CHIEN, Tu-Cheng (TW); HSIN-LI LIN, Tu-Cheng (TW); KUANG-WEI LIN, Tu-Cheng (TW); PO-YUAN LAI, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/957,335

(22) Filed: Dec. 14, 2007

(30) Foreign Application Priority Data
Oct. 5, 2007 (TW) 96137484

(51) Int. Cl. G03B 21/00

(52) U.S. Cl. 353/8

(57) ABSTRACT

A stereo projection optical system includes a polarizing beam splitter configured for splitting a light input into first, second polarized light components, first, second digital micro-mirror device respectively positioned to receive the first, second polarized light component and configured for superimposing spatial information on the first, second polarized light component, first, second total internal reflection prism configured for coupling the first, second polarized light component into the first, second digital micro-mirror device and a light combiner. The projecting lens projects two images formed by the first polarized light component and the second polarized light component with spatial information in the stereo projection optical systems. When a viewer wear glasses that have two polarizing lenses whose polarization direction is perpendicular to each other, the viewer can perceive projected images as being “3-D”.

### RELATED FIELD

The present invention relates generally to projection optical systems, and more specifically to a stereo projection optical system.

### BACKGROUND

A conventional stereoscopic image display apparatus for displaying a stereoscopic image on a display screen as shown in FIG. 3, uses a pair of image signals generated by two video cameras 32, 33 located at a predetermined distance from an object 31 with a predetermined separation therebetween. The pair of image signals is then displayed on a single display screen 36 by two display devices, such as projectors, 34, 35, respectively, overlapping each other.

However, such conventional stereoscopic image display apparatus have drawbacks in that they require two separate display devices. This causes an increase in the size of the stereoscopic image display device and complicates its mechanical structure.

It is desired to provide a stereo projection optical system which can overcome the above-described deficiencies.

### SUMMARY

In accordance with an exemplary embodiment, a stereo projection optical system includes a polarizing beam splitter, a first digital micro-mirror device, a second digital micro-mirror device, a first total internal reflection prism, a second total internal reflection prism, and a light combiner. The polarizing beam splitter is configured for separating a light input into a first polarized light component and a second polarized light component, which is substantially orthogonal to the first polarized light component. The first total internal reflection prism is positioned to receive the first polarized light component and configured for reflecting the first polarized light component to the first digital micro-mirror device. The second total internal reflection prism is positioned to receive the second polarized light component and configured for reflecting the second polarized light component to the second digital micro-mirror device. The first digital micro-mirror device is configured for superimposing spatial information on the first polarized light component and reflecting the first polarized light component having the spatial information to and through the first total internal reflection prism. The second digital micro-mirror device is configured for superimposing spatial information on the second polarized light component and reflecting the second polarized light component having spatial information to and through the second total internal reflection prism. The light combiner is positioned to receive and combine the light outputs from the first and second total internal reflection prism and configured to produce a single light output.

Other novel features and advantages will become more apparent from the following detailed description when taken in conjunction with the accompanying drawings.

### BRIEF DESCRIPTION OF THE DRAWINGS

The present invention is described in detail hereinafter, by way of example and description of preferred and exemplary embodiments thereof and with reference to the accompanying drawings, in which:

FIG. 1 illustrates a configuration of a stereo projection optical system in accordance with a first embodiment of the present invention;

FIG. 2 is similar to FIG. 1, but further illustrates a plurality of analyzers disposed in the stereo projection optical system.

FIG. 3 illustrates a configuration of a conventional stereoscopic image display apparatus.

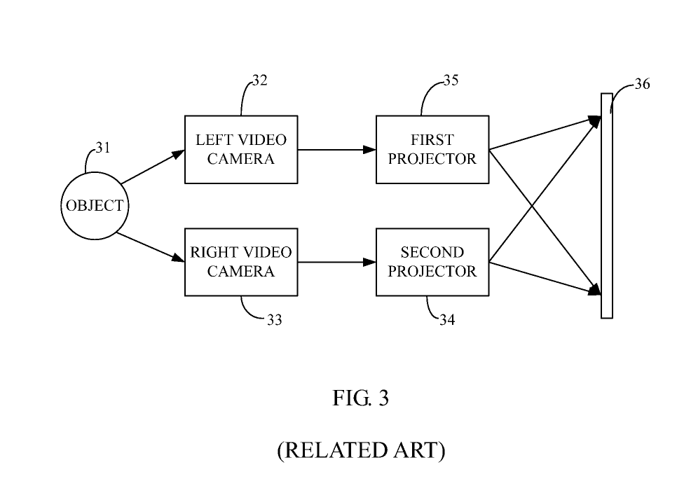

### DETAILED DESCRIPTION OF THE PREFERRED EMBODIMENTS

A detailed explanation of a stereo projection optical system according to each of various embodiments of the present invention will now be made with reference to the drawings attached hereto.

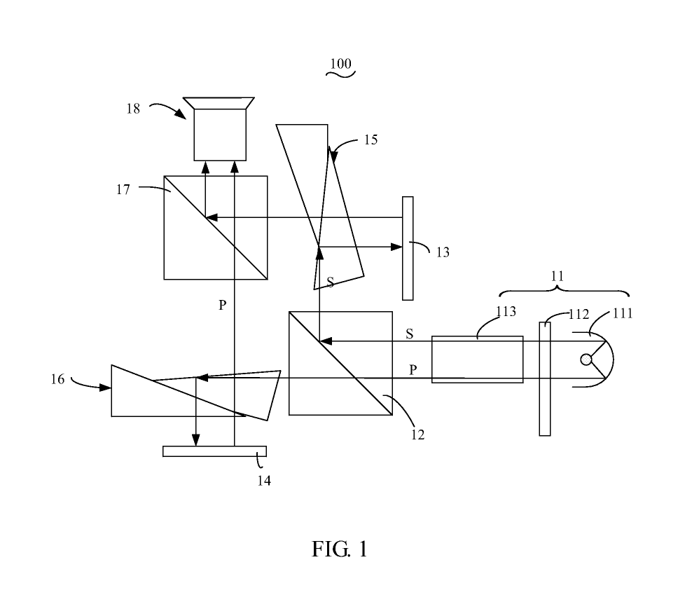

Referring to FIG. 1, a stereo projection optical system 100 according to a first embodiment in the present invention is shown. The stereo projection optical system 100 includes a light source assembly 11, a polarizing beam splitter (PBS) 12, a first digital micro-mirror device (DMD) 13, a second DMD 14, a first total internal reflection prism (TIR) 15, a second total internal reflection prism 16, a light combiner 17, and a projecting lens 18.

The light source assembly 11 includes a light source 111, a color wheel 112 positioned to receive light from the light source 111, and an integrator 113 positioned to receive light emerging from the color wheel 112. The light source 111 can be a halogen lamp, a metal halogen lamp, a light emitting diode (LED), and the like. In the present embodiment, the light source 111 is a halogen lamp that emits a white light. The color wheel 112 is configured for splitting the light output from the light source 111 into time-sequenced red, green, and blue light beams. The color wheel 112 includes red, green, and blue color filters, and the center of the color wheel 112 is connected to a motor (not shown) such that the color wheel 112 can be rotated. The integrator 113 is configured for changing the light beam emitted from the color wheel 112 such that light beams exiting the integrator 113 have uniform spatial distribution.

The PBS 12 is positioned to receive light output from the light source assembly 11, and is configured for separating the non-polarized light beam into two polarized light outputs. The polarized light outputs include a first polarized light component and a second polarized light component, which is substantially orthogonal to the first polarized light component. The first polarized light component can be S-polarized light or P-polarized light. When the first polarized light component is S-polarized light, the second polarized light component is P-polarized light. In the present embodiment, the first polarized light component is S-polarized light, and the second polarized light component is P-polarized light. The S-polarized light is reflected by the PBS 12 and the P-polarized light is transmitted directly through the PBS 12. The PBS 12 can be a wire grid polarization (WGP) or a polarizing beam splitter prism. In the present embodiment, the PBS 12 is a polarizing beam splitter prism.

The first, second TIRs 15, 16 are respectively positioned to receive the S-polarized light and the P-polarized light output from the PBS 12 and configured for respectively reflecting the first and second polarized light components to the first, second DMDs 13, 14.

The first, second DMDs 13, 14 are positioned to receive the S-polarized light and the P-polarized light reflected from the first and second TIRs 15, 16. The first and second DMDs 13, 14 are configured for respectively superimposing spatial information on the S-polarized light and P-polarized light and reflecting the S-polarized light having the spatial information and the P-polarized light having the spatial information. The S-polarized light having the spatial information passes through the first TIR 15 and reaches the light combiner 17. The P-polarized light having spatial information passes through the second TIR 16 and reaches the light combiner 17.

The light combiner 17 is positioned to receive the light outputs of the first, second TIRs 15, 16, and is configured for combining the light outputs to produce a single light output. The light combiner 17 can be a dichroic beam splitter or an X-prism. Where the light combiner 17 is an X-prism, it may include one or more dichroic filters and may also include a polarizing beam splitter. It should be noted that the X-prism is an optical element having two planes that lie substantially orthogonal to one anther. In the present embodiment, the two planes are dichroic filters configured for substantially transmitting light having a first wavelength and substantially reflecting light having a second wavelength.

The projecting lens 18 is configured for receiving the light output of the light combiner 17 and magnifying and projecting an image on a screen (not shown).

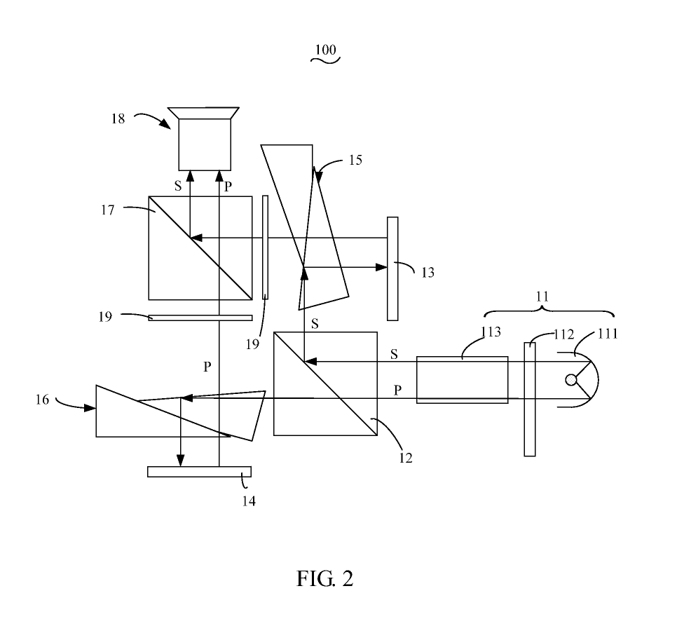

Referring to FIG. 2, this shows the addition of two analyzers 19 in order to enhance contrast of images projected by the stereo projection optical system 100′. Each analyzer 19 can be a polarizer, which is configured for transmitting light of a predetermined polarization direction and removing light of other polarization direction. In alternative embodiments, the analyzers 19 can have other desired light processing characteristics. The plurality of analyzers 19 can be disposed in any one or more of the following positions: between the first TIR 15 and the light combiner 17, between the second TIR 16 and the light combiner 17. In the present embodiment, the two analyzers 19 are respectively disposed in these two positions. One analyzer 19 transmits P-polarized light and removes S-polarized light and is disposed between the second TIR 16 and the light combiner 17. Another analyzer 19 transmits S-polarized light and removes P-polarized light is disposed between the first TIR 15 and the light combiner 17.

The projecting lens 18 projects two images formed by the S-polarized light and the P-polarized light having spatial information in the stereo projection optical systems 100 and 100′. When a viewer wear glasses that have two polarizing lenses whose polarizations are perpendicular to each other, the viewer can perceive projected images as being “3-D”. From the foregoing, it will be apparent that the stereo projection optical systems 100, 100′ according to the present invention provides advantages in that their structure can be simplified with their reduction of size by synthesizing left and right image signals and displaying the stereoscopic image with a single projecting lens 18.

It should be understood that the above-described embodiment are intended to illustrate rather than limit the invention. Variations may be made to the embodiments without departing from the spirit of the invention. Accordingly, it is appropriate that the appended claims be construed broadly and in a manner consistent with the scope of the invention.

What is claimed is:

1. A stereo projection optical system, comprising:
a polarizing beam splitter configured for separating a light input into a first polarized light component and a second polarized light component which is substantially orthogonal to the first polarized light component;
a first total internal reflection prism positioned to receive the first polarized light component and configured for reflecting the first polarized light component;
a second total internal reflection prism positioned to receive the second polarized light component and configured for reflecting the second polarized light component;
a first digital micro-mirror device positioned to receive the first polarized light component reflected from the first total internal reflection prism and configured for superimposing spatial information on the first polarized light component and reflecting the first polarized light having the spatial information to and through the first total internal reflection prism;
a second digital micro-mirror device positioned to receive the second polarized light component reflected from the second total internal reflection prism and configured for superimposing spatial information on the second polarized light component and reflecting the second polarized light having spatial information to and through the second total internal reflection prism; and
a light combiner positioned to receive and combine light outputs of the first and second total internal reflection prism and configured to produce a single light output.

2. The stereo projection optical system as claimed in claim 1, wherein the polarizing beam splitter is a wire grid polarizer.

3. The stereo projection optical system as claimed in claim 1, wherein the polarizing beam splitter is a polarizing beam splitter prism.

4. The stereo projection optical system as claimed in claim 1, wherein the light combiner is an X-prism.

5. The stereo projection optical system as claimed in claim 1, wherein the light combiner is a polarizing beam prism.

6. The stereo projection optical system as claimed in claim 5, wherein the polarizing beam prism is a wire grid polarizer.

7. The stereo projection optical system as claimed in claim 5, wherein the polarizing beam prism is a polarizing beam splitter prism.

8. The stereo projection optical system as claimed in claim 1, further comprising a projecting lens positioned to receive the emergent light of the light combiner and configured for projecting an image.

9. The stereo projection optical system as claimed in claim 1, further comprising a plurality of analyzers respectively disposed between the first and second total internal reflection prism and the light combiner.

10. The stereo projection optical system as claimed in claim 9, wherein the analyzer is a polarizer.
